(19) United States
(12) Patent Application Publication
(10) Pub. No.: US 2019/0039300 A1
(43) Pub. Date: Feb. 7, 2019

(54) AUTOMATIC SPREADER BAR BLADE MATERIAL POSITIONING FOR ADDITIVE MANUFACTURING

(71) Applicant: HEWLETT-PACKARD DEVELOPMENT COMPANY, L.P., Houston, TX (US)

(72) Inventors: James Charles MCKINNELL, Corvallis, OR (US); Mohammed Saad SHAARAWI, Corvallis, OR (US); David Alan CHAMPION, Corvallis, OR (US)

(73) Assignee: HEWLETT-PACKARD DEVELOPMENT COMPANY, L.P., Houston, TX (US)

(21) Appl. No.: 16/074,626

(22) PCT Filed: Jan. 27, 2017
(86) PCT No.: PCT/US2017/015291

§ 371 Date: Aug. 1, 2018

(51) Int. Cl. B29C 64/214; B33Y 10/00; B33Y 30/00; B33Y 50/02; B29C 64/393; B29C 64/153; B23K 26/342

(52) U.S. Cl. CPC B29C 64/214; B33Y 10/00; B33Y 30/00; B29K 2077/00; B29C 64/393; B29C 64/153; B23K 26/342; B33Y 50/02

(57) ABSTRACT

In one example, an additive manufacturing system. The system includes a blade spanning at least a portion of a build bed along a y axis and movable across the build bed along an x axis orthogonal to the y axis. The blade includes blade material to spread build material on the build bed. The system further includes a blade positioning mechanism coupled to the blade to position a different portion of the blade material adjacent a given y position of the build bed.

### BACKGROUND

In additive manufacturing systems, a physical three-dimensional (3D) object is fabricated layer-by-layer from a computer model of the 3D object. Some additive manufacturing systems form the 3D object from a build material, which may be polyamide, resin, ceramic, or metal in powder form, and/or another material and/or form. In such systems, a layer of the build material is deposited on a build bed, and the portions of the layer of the build material which correspond to structure defined by a corresponding a “slice” of the computer model of the 3D object are selectively fused together to form that layer of the 3D object. To ensure that the fabricated 3D object is of high quality, the surface of the build material layer should be uniform.

### BRIEF DESCRIPTION OF THE DRAWINGS

FIG. 1A is a schematic perspective representation of an additive manufacturing system in accordance with an example of the present disclosure.

FIG. 1B is a schematic perspective representation of another additive manufacturing system in accordance with an example of the present disclosure.

FIG. 2A is a schematic top view representation of another additive manufacturing system in accordance with an example of the present disclosure.

FIGS. 2B and 2C are schematic side view representations of the spreader bar and a blade of blade material of the additive manufacturing system of FIG. 2A in accordance with an example of the present disclosure.

FIGS. 3A through 3F are a sequence of schematic top view representations of an example operation of an additive manufacturing system to remediate a blade-related defect in a top surface of build material of the system of FIG. 1A, FIG. 1B, or FIG. 2, in accordance with an example of the present disclosure.

FIG. 4 is a flowchart in accordance with an example of the present disclosure of a method of fabricating a 3D object with an additive manufacturing system.

FIG. 5 is a block diagram representation of a controller usable with the additive manufacturing system of FIG. 2A, in accordance with an example of the present disclosure.

### DETAILED DESCRIPTION

In additive manufacturing, a 3D computer model (a 3D digital representation of design parameters) of a part to be fabricated may be divided (“sliced”) into a series of thin, adjacent parallel planar slices. The 3D part may then be fabricated layer-by-layer. Each slice of the 3D representation generally corresponds to a layer of the physical object to be fabricated. During fabrication, the next layer is formed on top of the adjacent previous layer. In one example, each layer is about 0.1 millimeter in thickness.

The build material used to fabricate the 3D object may be contained within the system in a build tray, which may be a removable element of the system. The build tray may include a build plate, on which the initial layer of the build material is directly deposited, with each subsequent layer of the build material deposited substantially on top of the prior layer of the build material. The term “build bed” may be used to refer to the build tray and the layers of deposited build material on top of the build plate.

In one example, the build material is a fine powder (particulate material), such as for example polyamide (nylon). In another example, the build material is a metal powder, such as for example steels, stainless steels, titanium alloys, among others. Other build materials may be powders of a different composition and/or having a different cohesive strength. At least one build tray may be processed by the additive manufacturing system at a time. During fabrication of each layer of a part, in one example the regions of the build material which correspond to the location of the part within the corresponding slice, are selectively fused or bound together, while the other regions remain in unfused or unbound form. Once the part is completely fabricated, any remaining unfused or unbound build material may be removed, and may be reused.

In one example, the additive manufacturing system has a build mechanism which uses a laser to selectively fuse the build material layer-by-layer. To do so, the laser is accurately positioned to irradiate the regions of the build material to be fused in each layer. Such a laser-based system with accurate position control for the fusing laser may be costly. Another example additive manufacturing system has a build mechanism that uses a simpler and less expensive heat source to fuse the build material in each layer, rather than a laser. The build material may be of a light color, which may be white. In one example, the build material is a light-colored powder. A print engine controllably ejects drops of a liquid fusing agent onto the regions of powder which correspond generally to the location of the cross-section of the part within the corresponding digital slice. The print engine, in an example, uses inkjet printing technology. In various examples, the fusing agent is a dark colored liquid such as for example black pigmented ink, a UV absorbent liquid or ink, and/or other liquid(s). A heat source, such as for example one or more infrared fusing lamps, is then passed over the entire print zone. The regions of the powder on which the fusing agent have been deposited absorb sufficient radiated energy from the heat source to melt the powder in those regions, fusing that powder together and to the previous layer underneath. However, the regions of the powder on which the fusing agent have not been deposited do not absorb sufficient radiated energy to melt the powder. As a result, the portions of the layer on which no fusing agent was deposited remain in unfused powdered form. To fabricate the next layer of the part, another layer of powder is deposited on top of the layer which has just been processed, and the printing and fusing processes are repeated for the next digital slice. This process continues until the part has been completely fabricated.

One class of commercial metal additive manufacturing systems uses lasers to selectively melt powder (similar to selective laser sintering). Another class uses an electron beam to selectively melt powder. Yet another class of commercial metal systems selectively deposits a polymer binder into the metal powder to selectively adhere the powder to form a green state part, after which the binder is dried or cured.

Depositing uniform layers of the build material on the build bed helps ensure that the fabricated 3D object will be of high-quality. In one example, a uniform layer has a uniform thickness. In one example, a uniform layer has a smooth top surface, regardless of whether or not the layer is of uniform thickness (for example, the underlying layer with which it is in contact may not have a uniform thickness). To achieve a uniform layer of the build material prior to performing the fusing operation, a spreader bar may be used. A blade of the spreader bar engages or contacts the build material and spreads it into a uniform layer. In some examples, the blade may be of a relatively hard material, such as for example tool steel or a ceramic. In other examples, the blade material may be made of softer, low durometer materials such as for example silicone rubber. A softer material, however, may be subject to wear, and the amount of wear may increase over time. In one example, a blade made of a softer material may be used for harder build materials such as metal powders, in order to prevent damage to the 3D object being fabricated, and/or to the additive manufacturing system itself, if the spreader bar happens to contact a fused portion of the underlying layer during the spreading operation. Use of a softer blade material can localize any collision-related damage to the blade itself, rather than to the 3D object or the system. In another example, material can build up in the brush and be redeposited or dragged elsewhere during the spreading operations.

The damage may take the form of a notch in the blade, or a protrusion from the blade. Such defects in the blade, or blade material, may render it unable to properly smooth the build material into a uniform layer. In some cases, instead of the build material having a smooth, even surface, the blade damage may cause the build material surface to have ridges and/or valley that extend outside acceptable limits for surface flatness. If the build process continues with a defective blade, rather than being detected and corrected at that time, the quality of the resulting 3D object fabricated using the defective blade may be unacceptable. Significant cost and time may be incurred in re-fabricating another copy of the 3D object. Other forms of blade-related defects, such as a buildup of build material on or near the edge of the blade, may also adversely affect the ability of the blade to properly smooth the build material into a uniform layer.

Referring now to the drawings, there is illustrated an example of an additive manufacturing system which has a spreader bar which traverses (or “scans”) a build bed to spread the build material into a uniform layer. The system automatically repositions blade material of the spreader bar during fabrication of a 3D object. This repositioning may prevent, inhibit, remediate, and/or compensate for damage to a blade of the spreader bar.

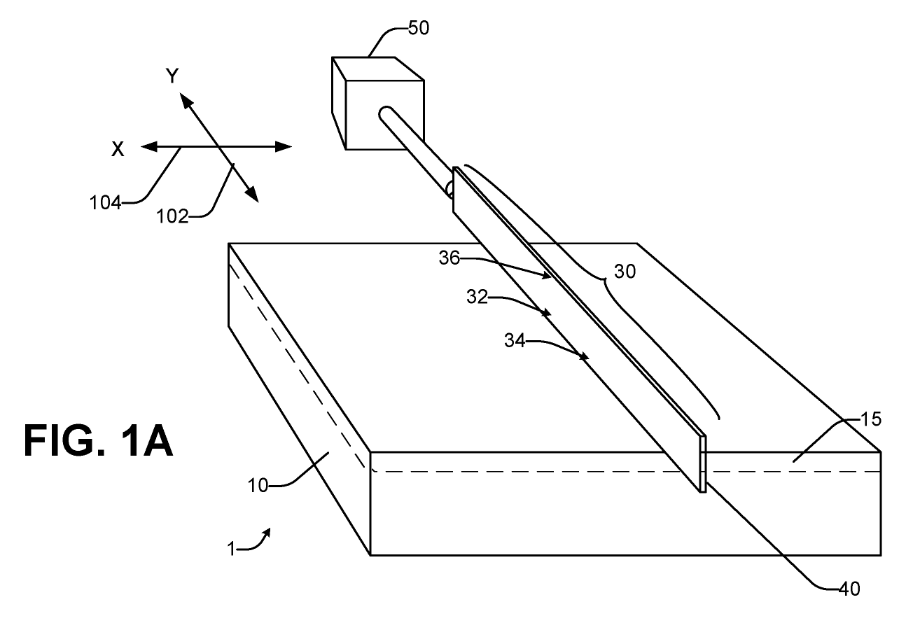

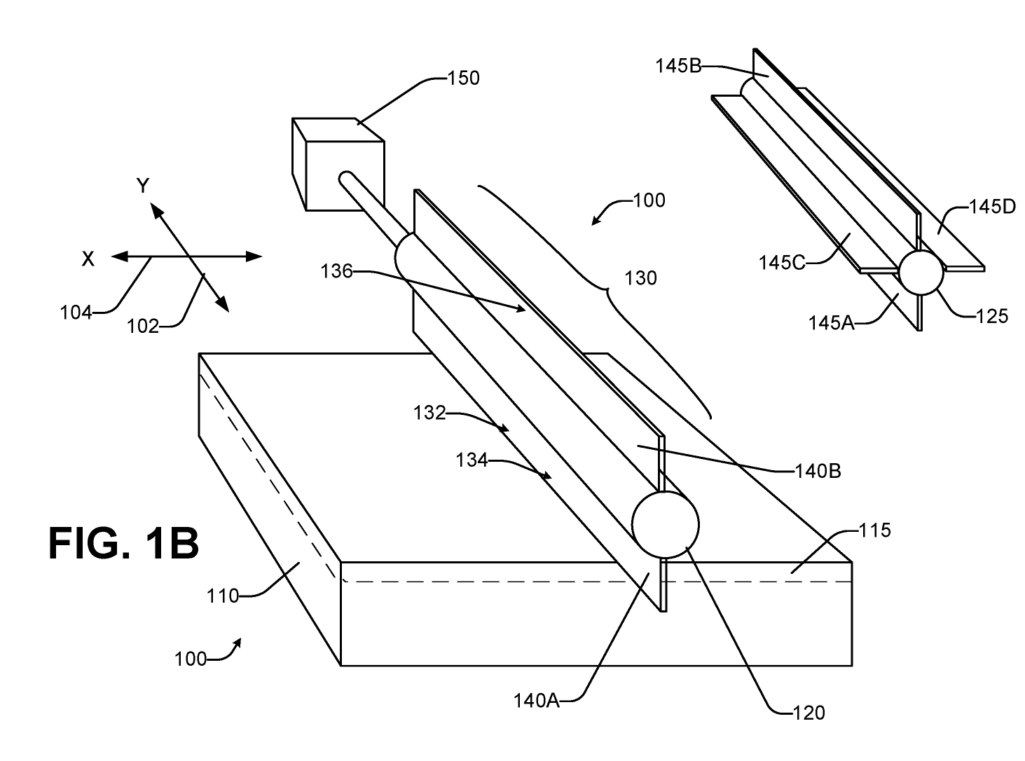

Considering now one example additive manufacturing system, and with reference to FIG. 1A, an additive manufacturing system 1 includes a blade 40. The blade 40 comprises blade material 30. The blade 40 and/or blade material 30 span at least a portion of a build bed 10 along a y axis 102. The blade 40 is movable across the build bed 10, in a reciprocal manner, along an x axis 104 which is orthogonal to the y axis 102. In this way, the blade 40 can traverse the entire build bed 10 to spread build material on the build bed to form a uniform top layer 15 of the build bed 10.

The additive manufacturing system 1 also includes a blade positioning mechanism 50 coupled to the blade 40. The blade positioning mechanism 50 can controllably position a different portion of the blade material 30 at a given y position on the build bed 10.

In one repositioning example, the blade positioning mechanism 50 moves the blade 40 linearly along the y axis 102. For example, assume that the blade material at location 32 is positioned adjacent a given y position on the build bed 10. The blade positioning mechanism 50 can linearly move (or “jog”) the blade 40 such that the blade material at location 34 is positioned adjacent the given build bed y position instead. The direction and/or amount of linear movement of the blade 40 may be predetermined, or may be random.

In another repositioning example, the blade positioning mechanism 50 rotates the blade 40 around a central axis of the blade 40 by substantially 180 degrees. For example, the blade positioning mechanism 50 can “flip” the blade 40 such that the blade material on an opposite edge of the blade at location 36 is positioned at the given build bed y position, replacing the blade material at location 32.

Considering now another example additive manufacturing system, and with reference to FIG. 1B, an additive manufacturing system 100 includes a spreader bar 120. The spreader bar 120 spans at least a portion of a build bed 110 along a y axis 102. In some examples, the spreader bar 120 is longer along the y axis 102 than the build bed 110. The spreader bar 120 is also movable across the build bed 110, in a reciprocal manner, along an x axis 104 which is orthogonal to the y axis 102. In this way, the spreader bar 120 can traverse the entire build bed 110 to spread the build material. In some examples, the build material may be spread in a single unidirectional pass of the spreader bar 120 over the build bed 110, while in other examples the build material may be spread in two bidirectional passes of the spreader bar 120 over the build bed 110. Other combinations of passes are also possible.

The spreader bar 120 has blade material 130 mounted to the spreader bar 120. The blade material 130 is formed into one or more blades 140 (in this example, two blades 140A, 140B). In some examples, the blades 140 and/or blade material 130 may be replaceable on the spreader bar 120. The blades 140 and/or blade material 130 span at least a portion of the build bed 110 along the y axis 102. In some examples, the blades 140 and/or blade material 130 are substantially the length along the y axis 102 of the spreader bar 120 and between 10% and 50% longer along the y axis 102 than is the build bed 110, which facilitates the jogging of the spreader bar 120 which is discussed subsequently. The blades 140 and/or blade material 130 spread build material, such as a powder, on the build bed 110 to form a uniform top layer 115 of the build bed 110. The spreader bar 120 may have a circular cross-sectional shape, or may have the cross-sectional shape of an N-sided polygon (e.g. hexagon, octagon, etc.)

The build bed 110 may be implemented using a frame or box having a plate movable in the Z-direction, initially set even with the top of the frame and lowered by the thickness of the build material for each layer. After the moveable plate is lowered, a layer of powder is spread across the top of the moveable platform such that the top surface of the powder layer is even with the top of the frame. The height of the movable plate may be controlled with a stepper motor or other linear actuator. A gasket between the moveable plate and the frame/box helps minimize powder leakage past the moveable plate. In some examples, the build bed 150 may range from 5 cm to 50 cm in length, width, and height.

The additive manufacturing system 100 includes a blade positioning mechanism 150 coupled to the spreader bar 120. The blade positioning mechanism 150 can controllably position a different portion of the blade material 130 at a given y position on the build bed 110.

In one example, the blade positioning mechanism 150 moves the spreader bar 120 linearly along the y axis 102. For example, assume that the blade material at location 132 is positioned adjacent a given y position on the build bed 110. The blade positioning mechanism 150 can linearly move (or “jog”) the spreader bar 120 such that the blade material at location 134 is positioned adjacent the given build bed y position instead. In this case, the blade material at locations 132, 134 is disposed on the same blade 140A. The direction and/or amount of linear movement of the spreader bar 120 may be predetermined, or may be random. In another example, the actuator 150 moves the spreader bar angularly in an arc, similar to a windshield wiper blade. This angular motion may be performed as one way to spread the build material on the build bed 110.

In another example, the blade positioning mechanism 150 rotates the spreader bar 120 around the y axis 102. For example, the blade positioning mechanism 150 can rotate the spreader bar 120 such that the blade material at location 136 is positioned at the given build bed y position instead of the blade material at location 132. In this case, the blade material at location 136 is disposed on a different blade 140B than the blade material at location 132, which is disposed on blade 140A. As a result, the rotation of the spreader bar 120 effectively selects blade 140B to replace blade 140A for use in spreading the build material in the build bed 110. Because the blades 140A and 140B are opposite each other on the spreader bar 120, the blade positioning mechanism 150 rotates the spreader bar 120 substantially 180 degrees.

The blade positioning mechanism 150 may be implemented using, for jogging of the spreader bar 120, a stepper motor coupled with a linear actuator, a four bar linkage or another form of linear actuator. Rotation of the spreader bar 120 can be performed with a stepper motor. In some examples, a locking cam or ratchet is used to ensure that the wiper blade is locked into the proper angular position.

While spreader bar 120 includes two blades, another example spreader bar 125 usable in the system 100 includes four blades 145A-145D disposed angularly around a central axis, in one example a central axis of the spreader bar 120. Other spreader bars 120 may include fewer or more blades. The amount, and in some examples the direction, of rotation performed by the blade positioning mechanism 150 corresponds to the angular position around the spreader bar 120 of the current blade 145 and the replacement blade 145. The various blades of the spreader bar 120, 125 may be substantially the same size or different sizes.

In some examples, the additive manufacturing system 100 automatically positions a different portion of blade material 130 adjacent a given y position of the build bed 110 during fabrication of a 3D object by the system 100. As is discussed subsequently in greater detail, this automatic repositioning of blade material 130 may be done periodically, or may be done in response to detection of a blade-related defect. In some examples, the repositioning of the blade material 130 is performed between traversals of the spreader bar 120 over the build bed 110. By automatically repositioning the blade material 130 during fabrication of the 3D object, defects in, or poor quality of, the fabricated 3D object can be avoided, along with the time, expense, and inconvenience of having to fabricate a replacement part.

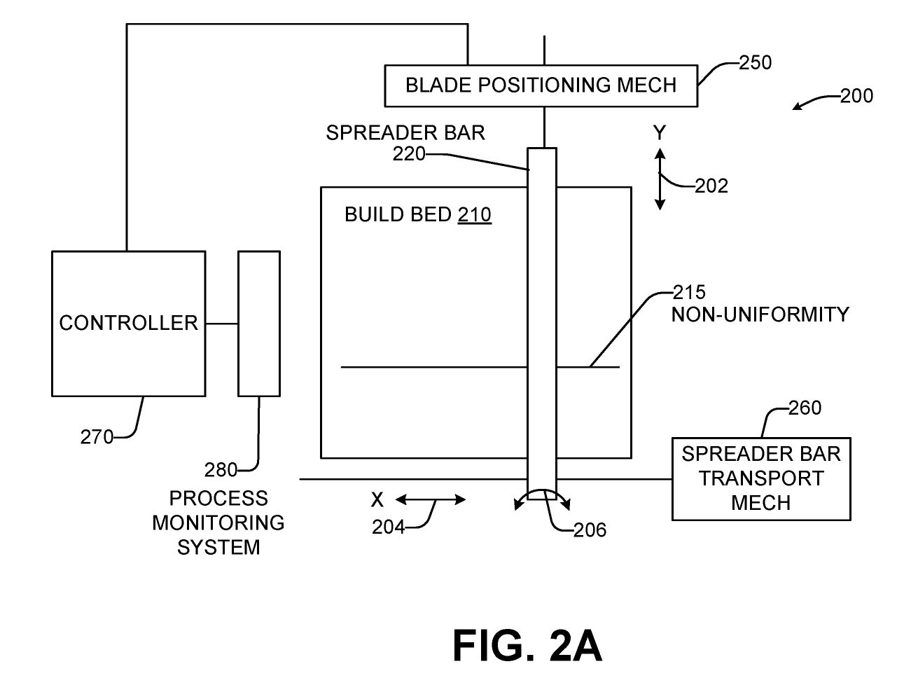

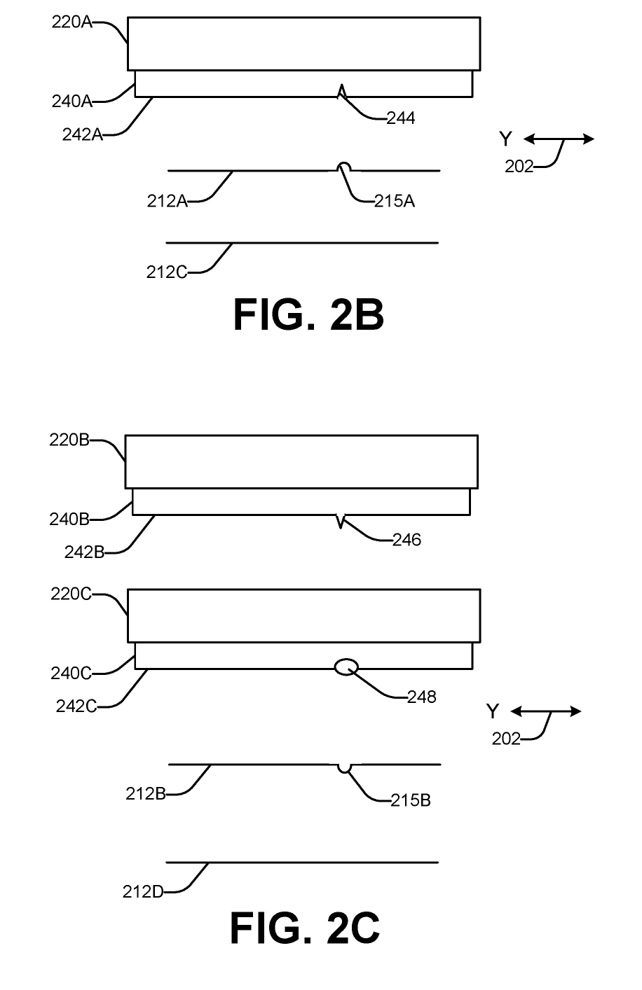

Considering now another example additive manufacturing system, and with reference to FIGS. 2A through 2C, an additive manufacturing system 200 includes a build bed 210, a spreader bar 220 which includes at least one blade 240 (240A, 240B, 240C) of blade material, and a blade positioning mechanism 250. In some examples, the build bed 210 and blade positioning mechanism 250 may be structurally and/or functionally the same as or similar to the build bed 10 and blade positioning mechanism 50 of the system 1 (FIG. 1A). In some examples, the build bed 210, spreader bar 220, and blade positioning mechanism 250 may be structurally and/or functionally the same as or similar to the build bed 110, spreader bar 120, and blade positioning mechanism 150 of the system 100 (FIG. 1B). The blade material and/or blades 240 may be structurally and/or functionally the same or similar to the blade material 30 and blade 40 (FIG. 1A), and/or the blade material 130 and blades 140 (FIG. 1B). The additive manufacturing system 200 has a Y-axis 202 which defines a transverse direction, and an X-axis 204 which defines a longitudinal direction, of relative movement of the spreader bar 220 and build bed 210. A spreader bar transport mechanism 260 reciprocally transports the spreader bar 220 in the direction of the X-axis 204 across the build bed 210 in order to spread the build material on the build bed 210. A spreading operation may move the spreader bar 220 unidirectionally (e.g. from one side of the build bed 210 to the other side) or bidirectionally (e.g. starting and ending on the same side of the build bed 210). In some examples, the spreading operation may be repeated during fabrication of a 3D object for a given build material layer without adding additional build material to the build bed 210. The may be done in order to prevent, mitigate, repair, and/or compensate for defects in uniformity of the build material layer.

A defect in the blade material of the spreader bar 220 can cause a non-uniformity 215 in the top surface of the build material in the build bed 210 as a result of moving the spreader bar 220 in the longitudinal direction 204 to spread the build material. The non-uniformity 215 may be, in various examples, at least one ridge and/or valley of build material in excess of acceptable limits for surface flatness of the build material. The non-uniformity 215 may, in some examples, substantially form a line extending across the build bed 210 in the longitudinal direction 204. The blade positioning mechanism 250 may be operated to jog the blade spreader bar 220 a distance in the direction of the Y-axis 202, and/or rotate the spreader bar 220 an angular distance in a direction 206 about its axis, in order to reposition blade material which in turn may prevent, mitigate, repair, and/or compensate for the non-uniformity 215.

The schematic side views of the spreader bar 220 of FIGS. 2B and 2C illustrate example types of blade material defects which may occur, and the non-uniformities 215 they can generate. In FIG. 2B, a blade 240A of the spreader bar 220A has a notch 244 in a lower portion 242C of the blade material. As the spreader bar 220A moves in the longitudinal direction 204 and spreads the build material in the build bed 210, a non-uniformity 215 in the build material, in the form of a ridge 215A (also referred to as a bulge) of build material extending in the longitudinal direction 204, can be formed in the top surface 212 of the build material. In FIG. 2C, a blade 240B of the spreader bar 220B has a protrusion 246 from a lower portion 242B of the blade material; and a blade 240C of the spreader bar 220C has a buildup of build material 248 on a lower portion 242B of the blade material. As the spreader bar 220B, 220C moves in the longitudinal direction 204 and spreads the build material in the build bed 210, a non-uniformity 215 in the build material, in the form of a valley 215B (also referred to as a groove or a gouge) of build material extending in the longitudinal direction 204, can be formed in the top surface 212 of the build material.

In some examples, if a ridge 215A and/or valley 215B occurs, positioning a different portion of the blade material at the Y-axis location of the ridge 215A and/or valley 215B can repair the surface 212 or lessen its severity. For example, by jogging the blade 240A a distance along the direction of the Y-axis 202, and then re-spreading the build material, the build material of the ridge 215A may be distributed to other locations to form an improved surface 212C. As another example, by rotating the spreader bar 220B, 220C to replace the blade 240B, 240C with another blade, and then re-spreading the build material, the valley 215B of the build material may be filled in with adjacent material to form an improved surface 212D.

The system 200 also includes a controller 270. The controller 270 is coupled to the blade positioning mechanism 250 to position a different portion of the blade material adjacent a given y position of the build bed 210. In some examples, the controller 270 may also control operation of the spreader bar transport mechanism 260. In one example, the spreader bar transport mechanism 260 may be implemented using a stepper motor which drives a belt that in turn is fastened to the spreader bar 220. In another example, a stepper motor turns a shaft which is perpendicular to the spreader bar 200, causing the spreader bar 220 to sweep angularly across the build bed 210. In yet another example, the spreader bar transport mechanism 260 moves the spreader bar 220 in a spiral pattern, which can have a shearing effect that may be advantageous for certain types of build materials.

In some examples, the controller 270 periodically operates the blade positioning mechanism 250 during fabrication of a 3D object to position a different portion of the blade material adjacent a given y position of the build bed 210. For example, the spreader bar 220 may be jogged in the direction of the Y-axis 202 periodically in order to distribute wear of the blade material more evenly, rather than concentrating it on the same portions during each spreading operation. As another example, the spreader bar 220 may be rotated periodically in order to use a new or different blade for the spreading operation. In some examples, both jogging and rotating the spreader bar 220 may be performed during fabrication of a 3D object.

In some examples, the system 200 further includes a process monitoring system 280 communicatively coupled to the controller 270 and operated by the controller 270. The process monitoring system 280 is operable to examine the blade or blade material of the spreader bar 220, and/or the surface of the build bed 210, in order to detect a defect related to the blade material. In some examples, this examination includes an automated visual examination using a vision system. The defect may be detected directly by examining the blade to, for example, determine whether the profile of the blade edge is within process limits. The defect may be detected indirectly by examining the surface layer of the build bed 210 to, for example, determine whether the smoothness of the surface layer is within process limits.

In some examples, the controller 270 operates the blade positioning mechanism 250 during fabrication of a 3D object to position a different portion of the blade material adjacent a given y position of the build bed 210 if it has been determined, for example by the process monitoring system 280, that a defect related to the blade material has occurred. In some examples, a spreading operation of the spreader bar 220 may be performed again for the same layer after the operation of the blade positioning mechanism 250 in order to mitigate, repair, and/or compensate for the effect on the build material layer of the blade-related defect.

In examples, repositioning of the blade material is performed between traversals of the spreader bar 220 over the build bed 210. For example, the repositioning is performed when the spreader bar 220 is at one of its terminal positions with respect to the build bed 210.

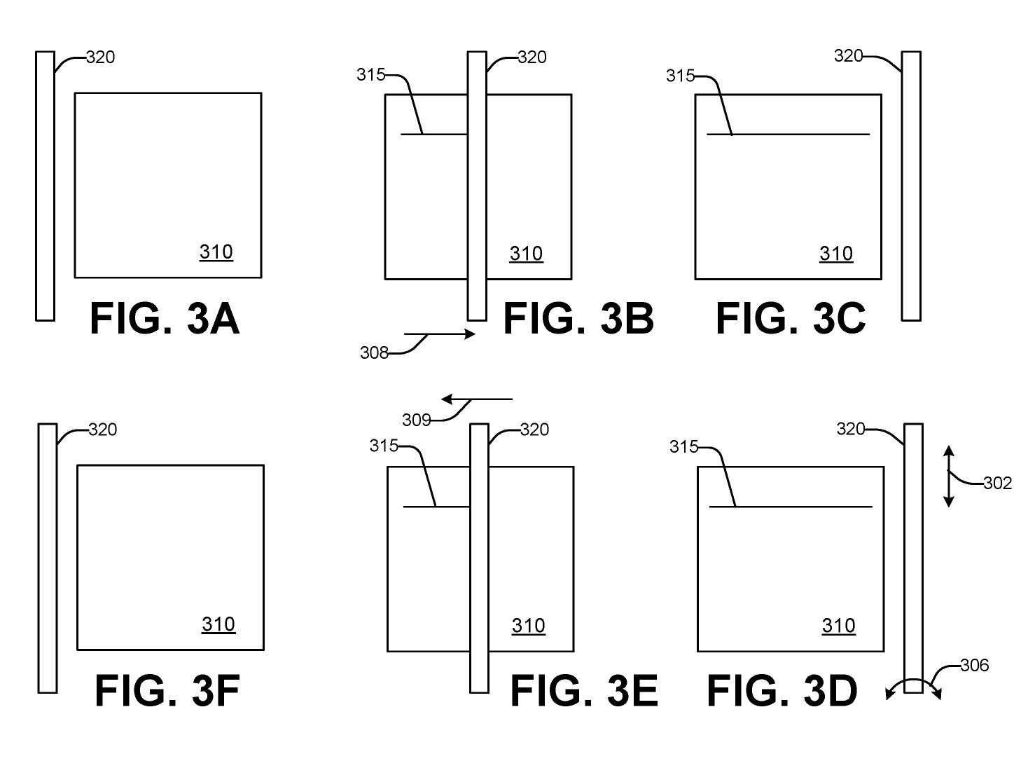

Considering now the operation of an additive manufacturing system to remediate a blade-related defect in a top surface of build material, and with reference to FIGS. 3A through 3F, a unidirectional spreading operation is employed for clarity of illustration, rather than a bidirectional spreading operation. The principles of unidirectional spreading are similarly applicable to bidirectional spreading.

FIGS. 3A through 3F illustrate traversal of a spreader bar 320 over a build bed 310 during a spreading operation. In FIG. 3A, the spreader bar 320 begins at a left terminal position. In FIG. 3B, the spreader bar 320 is in mid-traversal over the build bed 210 moving in the direction 308. In FIG. 3C, movement of the spreader bar 320 over the build bed 310 ends at a right terminal position. In unidirectional spreading, there is a single build material source location. In one example, the build material source location is along the left side of the build bed 310 between the spreader bar 320 and the build bed 310 (as in FIG. 3A), while in another example the build material source location is along the right side of the build bed 310 between the spreader bar 320 and the build bed 310 (as in FIG. 3C). After a unidirectional spreading operation, the spreader bar 320 returns to the location (e.g. the side of the build bed 310) where it began the spreading operation, so that the next time build material is dispensed to the source location, the spreader bar 320 will be in the correct position to begin spreading it on the build bed 310. In bidirectional spreading, there are two build material source locations. In one example, one build material source location is along the left side of the build bed 310, and the other build material source location is along the opposite, right side of the build bed 310. After build material is dispensed to a first source location that is adjacent a first terminal position of the spreader bar 320, the spreader bar 320 spreads the build material across the build bed 310 as it moves to its opposite, second terminal position, where it remains during the fabrication of the layer of the 3D object which corresponds to the spread build material. After the build bed 310 is lowered, build material is dispensed to the second source location which is now adjacent the second terminal position of the spreader bar 320, and the spreader bar 320 spreads the build material from the second source location across the build bed 310 and returns to the first terminal location.

Assume that the spreader bar 320 has a defect in the blade material used to perform the spreading operation of FIGS. 3A-3C. This defect causes a non-uniformity 315 in the top surface of the build bed 310 to progressively be formed as the spreader bar 320 traversed the build bed 310. If that defect is detected, the blade positioning mechanism can control the spreader bar 320 to remediate it in the current layer through the operations of FIG. 3D-3F.

In FIG. 3D, before traversing the build bed in the opposite direction 309, the spreader bar 320 is jogged along axis 302, and/or rotated 306 around its axis, which positions different blade material adjacent the non-uniformity 315. In some examples, jogging, rotating, or both could be performed. In some examples, the type of repositioning depends on the characteristics of the non-uniformity 315. For example, if the non-uniformity 315 is a ridge in the top layer of build material, the spreader bar 320 could be joggled to move the blade material defect to a different position in the direction 302, but if the non-uniformity 315 is a valley in the top layer of the build material, the spreader bar 320 could be rotated to replace the current blade with a different blade that does not have the defect.

In FIG. 3E, the spreader bar 320 is in mid-traversal. The non-uniformity 315 has been remediated on the rightmost portion of the build bed 310, which has already been traversed by the spreader bar. The spreading operation ends with the spreader bar at the opposite terminal position (FIG. 3F) from where it began (FIG. 3D). Because the spreader bar 320 has now traversed the entire longitudinal span of the build bed 310, the non-uniformity 315 has been remediated throughout the build bed 310.

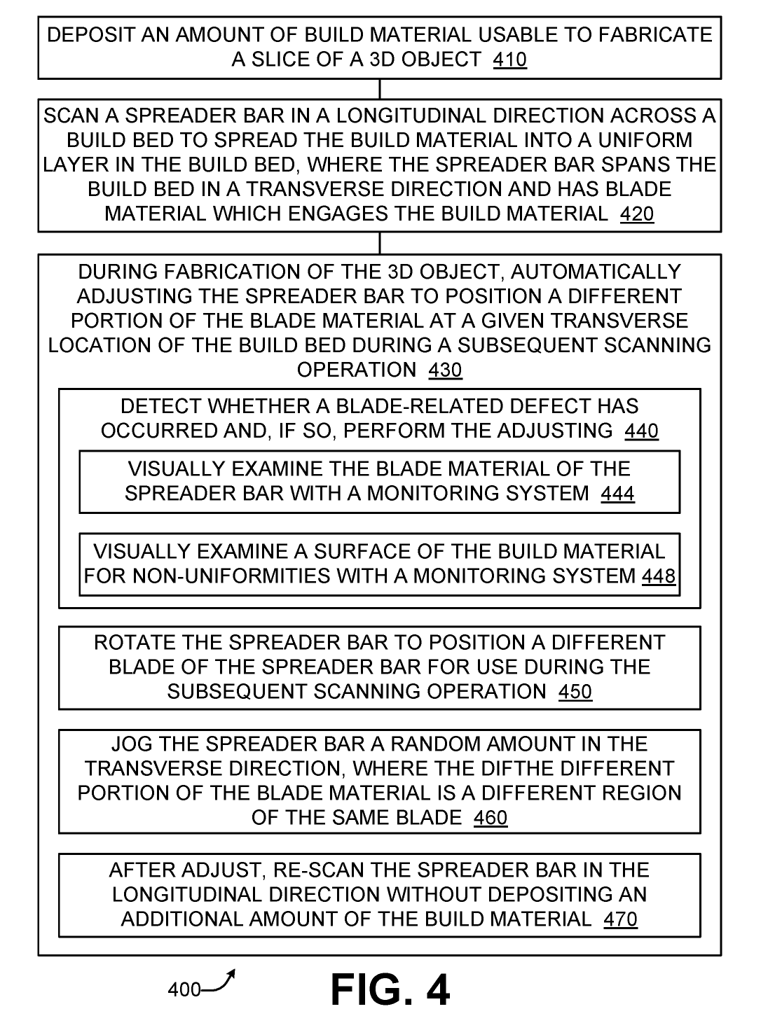

Considering now a method of fabricating a 3D object with an additive manufacturing system, and with reference to FIG. 4, a method 400 begins at 410 by depositing an amount of build material usable to fabricate a layer (slice) of the 3D object. In some examples, a metered amount of the build material (the amount corresponding to the volume of the layer) may be dispensed from a dispenser onto or at an initial position on or near the build bed.

At 420, a spreader bar is scanned in a longitudinal direction across the build bed to traverse the bed. The scanning spreads the deposited build material into a uniform layer in the build bed. The spreader bar spans at least a portion of the build bed in the transverse direction, and has blade material which engages the build material in order to spread it.

At 430, after the scanning and during fabrication of the 3D object, the spreader bar is automatically adjusted to position a different portion of the blade material of the spread bar adjacent to a given transverse location of the build bed during a subsequent scanning operation. This adjustment is performed to prevent, mitigate, repair, and/or compensate for defects in uniformity of the build material layer, such as ridges or valleys for example. In some examples, whether or not the automatic adjustment operation of 430 is performed depends on whether the occurrence of a blade-related defect has been detected at 440. In some examples, the automatic adjustment operation 430 may be performed after non-uniformities at substantially the same Y position are detected in multiple scans of the spreader bar; for example, this might help distinguish contaminants in a particular layer of the build material from a blade-related defect. The detection 440 may be performed using a process monitoring system which visually examines the blade material of the spreader bar at 444, and/or examines the top surface of the top layer of build material in the build bed (which will form the current slice of the 3D object being fabricated) at 448.

In some examples, the blade material forms plural blades of the spreader bar, and the adjusting 430 includes rotating, at 450, the spreader bar to position a different one of the blades for use during the subsequent scanning operation.

In some examples, the different portion of the blade material is a different region of blade material in the same blade, and the adjusting 430 includes jogging, at 460, the spreader bar a random amount and/or direction along the transverse (Y) axis to change the portion of the blade material that is positioned adjacent any given Y position of the build bed.

In some examples, after the adjusting 430, the spreader bar is re-scanned, at 470, in the longitudinal direction across the build bed without depositing an additional amount of the build material. The re-scanning 470 can remediate the non-uniformities in the layer of the build material which resulted from a blade-related defect in the previous traversal. In some examples, after the re-scanning 470, the detection 440 may again be performed to verify that the non-uniformity has been remediated. If not, further action may be taken. For example, if the jogging 460 was performed but a non-uniformity persists, the rotating 450 may be performed next for remediation purposes.

In some examples, FIG. 4 may be considered as at least a portion of a flowchart of a controller, such as for example the controller 270 (FIG. 2) of an additive manufacturing system, which orchestrates the operations of the method 400.

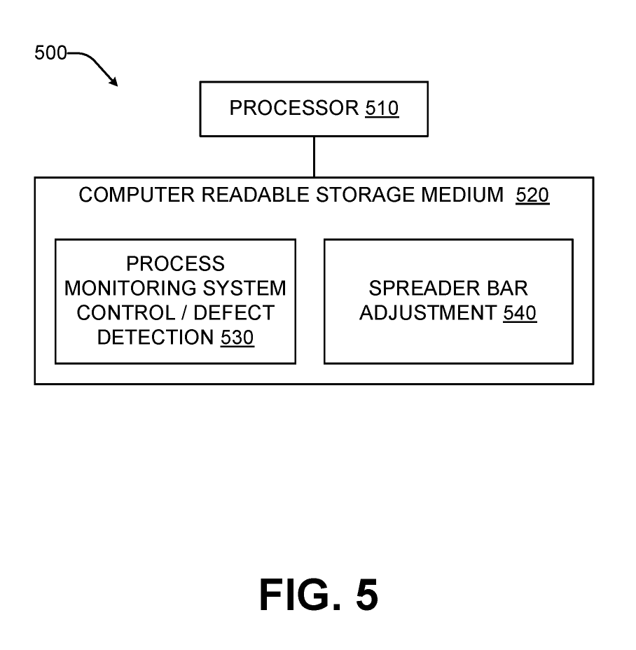

Considering now one example controller of an additive manufacturing system, and with reference to FIG. 5, a controller 500 includes a processor 510 coupled to a non-transitory computer-readable storage medium 520 which has stored program instructions executable by the processor 510. The program includes a process monitoring system control and defect detection module 530, and a spreader bar adjustment module 540.

The process monitoring system control and defect detection module 530 operates a process monitoring system to detect, during fabrication of a 3D object, a defect in blade material of a spreader bar. The blade material is engageable with a layer of build material in a build bed for the 3D object to smooth a surface of the layer, and the defect can cause a non-uniformity in the layer which adversely affects quality of the fabricated 3D object. In some examples, the module 530 operates the process monitoring system to visually examine the blade material of the spreader bar to detect the defect, and/or to visually examine a surface of the layer to detect a non-uniformity.

The spreader bar adjustment module 540 operates a blade positioning mechanism to automatically adjust the spreader bar during the fabrication to position a different portion of the blade material adjacent a given transverse position of the build bed during a subsequent longitudinal traversal of the spreader bar with respect to the build bed.

In some examples, the module 540 jogs the spreader bar an amount and direction in an axial direction to position a different portion of the blade material to engage the given transverse position of the build bed during the subsequent longitudinal traversal. In some examples, the amount and/or direction of jogging may be random.

In some examples, the module 540 rotates the spreader bar in order to use a different blade of the blade material during the subsequent longitudinal traversal.

In some examples, the spreader bar is adjusted between longitudinal traversals of the spreader bar.

The controller 500 may be the controller 270 (FIG. 2); the process monitoring system may be the process monitoring system 260 (FIG. 2); and the blade positioning mechanism may be the blade positioning mechanism 50 (FIG. 1A), 150 (FIG. 1B), 250 (FIG. 2).

In some examples, the computer readable storage medium 520 includes different forms of memory including semiconductor memory devices such as DRAM, or SRAM, Erasable and Programmable Read-Only Memories (EPROMs), Electrically Erasable and Programmable Read-Only Memories (EEPROMs) and flash memories; magnetic disks such as fixed, floppy and removable disks; other magnetic media including tape; and optical media such as Compact Disks (CDs) or Digital Versatile Disks (DVDs). The instructions of the programs and modules discussed above can be provided on one computer-readable or computer-usable storage medium, or alternatively, can be provided on multiple computer-readable or computer-usable storage media distributed in a large system having possibly plural nodes. Such computer-readable or computer-usable storage medium or media is (are) considered to be part of an article (or article of manufacture). An article or article of manufacture can refer to any manufactured single component or multiple components.

In some examples, at least one block or step discussed herein is automated. In other words, apparatus, systems, and methods occur automatically. As defined herein and in the appended claims, the terms “automated” or “automatically” (and like variations thereof) shall be broadly understood to mean controlled operation of an apparatus, system, and/or process using computers and/or mechanical/electrical devices without the necessity of human intervention, observation, effort and/or decision.

From the foregoing it will be appreciated that the system, method, and medium provided by the present disclosure represent a significant advance in the art. Although several specific examples have been described and illustrated, the disclosure is not limited to the specific methods, forms, or arrangements of parts so described and illustrated. For example, examples of the disclosure are not limited to a movable spreader bar traversing a fixed build bed, but can be used in any configuration that allows relative movement between the spreader bar and the build bed. This description should be understood to include all combinations of elements described herein, and claims may be presented in this or a later application to any combination of these elements. The foregoing examples are illustrative, and different features or elements may be included in various combinations that may be claimed in this or a later application. Unless otherwise specified, operations of a method claim need not be performed in the order specified. Similarly, blocks in diagrams or numbers (such as (1), (2), etc.) should not be construed as operations that proceed in a particular order. Additional blocks/operations may be added, some blocks/operations removed, or the order of the blocks/operations altered and still be within the scope of the disclosed examples. Further, methods or operations discussed within different figures can be added to or exchanged with methods or operations in other figures. Further yet, specific numerical data values (such as specific quantities, numbers, categories, etc.) or other specific information should be interpreted as illustrative for discussing the examples. Such specific information is not provided to limit examples. The disclosure is not limited to the above-described implementations, but instead is defined by the appended claims in light of their full scope of equivalents. Where the claims recite “a” or “a first” element of the equivalent thereof, such claims should be understood to include incorporation of at least one such element, neither requiring nor excluding two or more such elements. Where the claims recite “having” or “including”, the term should be understood to mean “comprising”.

What is claimed is:

1. An additive manufacturing system, comprising:
a blade spanning at least a portion of a build bed along a y axis and movable across the build bed along an x axis orthogonal to the y axis, the blade comprising blade material to spread build material on the build bed; and
a blade positioning mechanism coupled to the blade to automatically position, during fabrication of a 3D object by the additive manufacturing system, a different portion of the blade material adjacent a given y position of the build bed.

2. The system of claim 1, comprising:
a spreader bar having the blade and coupled to the blade positioning mechanism.

3. The system of claim 2, wherein the blade positioning mechanism jogs the spreader bar along the y axis an amount and direction between traversals of the spreader bar over the build bed.

4. The system of claim 2, comprising:
plural blades of the blade material disposed angularly around a central axis, and
wherein the blade movement mechanism rotates the spreader bar to use a selected blade to spread the build material on the build bed.

5. The system of claim 2, comprising:
two blades of the blade material disposed at opposing locations on the spreader bar, and
wherein the blade movement mechanism flips the spreader bar substantially 180 degrees to use an opposite blade to spread the build material on the build bed.

6. The system of claim 1, comprising:
a process monitoring system to detect a defect related to the blade material, and
a controller coupled to the process monitoring system and the blade movement mechanism to position the different portion of the blade material adjacent the given y position in response to the detected defect.

7. A method of fabricating a 3D object with an additive manufacturing system, comprising:
depositing an amount of build material usable to fabricate a layer of the 3D object;
scanning a spreader bar across a build bed to spread the build material into a uniform layer in the build bed, the spreader bar spanning at least a portion of the build bed in a transverse direction and having blade material which engages the build material; and
after the scanning, and during fabrication of the 3D object, automatically adjusting the spreader bar to position a different portion of the blade material adjacent a given transverse location of the build bed during a subsequent scanning operation.

8. The method of claim 7, comprising:
after the scanning, detecting whether a blade-related defect has occurred and, if so, performing the adjusting.

9. The method of claim 7, wherein the blade material forms plural blades of the spreader bar, and wherein adjusting includes rotating the spreader bar to position a different blade for use during the subsequent scanning operation.

10. The method of claim 7, wherein the adjusting includes jogging the spreader bar a random amount in the transverse direction, and wherein the different portion of the blade material is a different region of the same blade.

11. The method of claim 7, comprising:
after the adjusting, re-scanning the spreader bar in the transverse direction without depositing an additional amount of the build material.

12. A non-transitory computer-readable storage medium having an executable program stored thereon, wherein the program instructs a processor to:
detect, during fabrication of a 3D object from build material, a defect in blade material of a spreader bar of an additive manufacturing system, the blade material engageable with a layer of the build material in a build bed to smooth a surface of the layer, the defect causing a non-uniformity in the layer; and
automatically adjust the spreader bar during the fabrication to position a different portion of the blade material adjacent a given transverse position of the build bed during a subsequent longitudinal traversal of the spreader bar with respect to the build bed.

13. The medium of claim 12, wherein the program further instructs the processor to:
visually examine at least one of the blade material of the spreader bar, and a surface of the layer, to detect the defect.

14. The medium of claim 12, wherein the program further instructs the processor to:
jog the spreader bar in an axial direction to position the different portion of the blade material to engage a given transverse position of the build bed during the subsequent longitudinal traversal.

15. The medium of claim 12, wherein the program further instructs the processor to:
rotate the spreader bar to use a different blade of the blade material during the subsequent longitudinal traversal.
